(19) United States
(12) Patent Application Publication
(10) Pub. No.: US 2014/0048017 A1
(43) Pub. Date: Feb. 20, 2014

(54) Dispensing Device for Animal Consumables and Methods of Using the Same

(71) Applicant: Radio Systems Corporation, Knoxville, TN (US)

(72) Inventors: Christopher E. Mainini, Knoxville, TN (US); Brad Allen, Stillwell, KS (US)

(73) Assignee: Radio Systems Corporation, Knoxville, TN (US)

(21) Appl. No.: 14/064,674

(22) Filed: Oct. 28, 2013

Related U.S. Application Data
(63) Continuation-in-part of application No. 12/886,811, filed on Sep. 21, 2010, now Pat. No. 8,596,220.

(51) Int. Cl. A01K 5/00; A01K 15/02

(52) U.S. Cl. CPC A01K 5/00; A01K 15/02
USPC 119/51.01

(57) ABSTRACT

Systems and methods of providing an edible consumable substance to an animal, and methods of training an animal, including the provision of a housing with an edible substance therein, a dispensing member provided at one end of the housing, the dispensing member having at least one aperture through which the edible substance is dispensed, a pushing member provided inside the housing to push the edible substance in a direction of the dispensing member, and a control interface to control the movement of the pushing member such that a user can control an amount of the edible substance that is provided to the animal through the dispensing member.

### CROSS-REFERENCE TO RELATED APPLICATIONS

This application is a continuation-in-part of U.S. patent application Ser. No. 12/886,811, filed on Sep. 21, 2010, the contents of which are incorporated by reference herein in its entirety.

### BACKGROUND OF THE INVENTION

1. Field of Invention

The present general inventive concept relates generally to systems and methods of dispensing consumable food supplements to animals, and more particularly, to a portable handheld apparatus to selectively, evenly, and cleanly dispense edible substances to animals to nourish, train, reward, and/or refresh the animal.

2. Description of the Related Art

Pet owners routinely encounter a variety of issues when engaging their pets in activities away from the home. For example, dog owners encounter issues associated with satisfying a dog's thirst and/or providing a treat to the dog as a reward for a desired exhibited behavior when the dog and owner are engaged on a walk or in other athletic or recreational activity. Efforts have been made to develop dispensing devices and/or systems to provide fluid refreshment to pets while the pet is in a cage or away from naturally occurring sources of fluid refreshment, but such known devices are typically inconvenient, messy, unhealthy, and/or impractical to be portably carried by the pet owner to nourish, train, reward, and refresh the pet during activities away from the home, and are less than satisfactory in portably and repetitively dispensing relatively small portions of a consumable substance for training purposes without satiating the animal, or in providing a quick method and convenient device to selectively provide variable quantities of consumable to the animal. Moreover, current treats and dispensers are typically messy (oily or crumbly), smelly, high in calories, expensive, are not easily accessible or portable. Current treats can also lack uniform size and can be filling to the animal when repetitively offered to the animal, causing lethargy and lack of interest in the animal, thus limiting the number of training/reward opportunities available during a particular activity. Such high calorie and filling treats are typically kept in the home, and are cumbersome to transport away from the home, reducing the number of training opportunities available when the pet and owner are away from the home.

### BRIEF SUMMARY OF THE INVENTION

The present general inventive concept provides systems and methods of dispensing consumable substances to animals using a handheld dispenser, including a control interface and dispensing grate that can dispense a user-determined amount of the edible substance to the animal when the animal licks an exposed surface of the dispenser. It is noted that the term ‘consumable’ or ‘substance’ may be interchangeably referred to herein as a ‘treat,’ ‘gel,’ or ‘edible substance’ for convenience of description, but the present general inventive concept is not limited to any particular type of edible animal consumable, treat, or substance.

Additional features and embodiments of the present general inventive concept will be set forth in part in the description that follows and, in part, will be obvious from the description, or may be learned by practice of the general inventive concept.

Example embodiments of the present general inventive concept can be achieved by providing a hand-held device to provide an edible substance to an animal, including a housing provided with an edible substance therein, a dispensing member provided at one end of the housing, the dispensing member having at least one aperture through which the edible substance is dispensed, the dispensing member having a first surface in communication with the housing and a second surface opposing the first surface, a pushing member provided inside the housing to push the edible substance in a direction of the first surface of the dispensing member and through the at least one aperture, and a control interface to control the movement of the pushing member such that a user can selectively control an amount of the edible substance that is pushed through the at least one aperture, wherein a viscosity of the edible substance and a configuration of the at least one aperture cooperate to facilitate adherence of a selected amount of edible treat on the dispensing member adjacent to the second surface of the dispensing member.

The edible substance may be a gel having at least one additive to provide one or more health promoting qualities to the animal.

The edible substance may include nutritional and/or breath freshening content.

The nutritional content may include antioxidants, anti-stress additives, antimicrobials, preservatives, skin and coat additives, immunity additives, digestive additives, bone and joint additives, energy enhancers, weight management additives, cognitive enhancers, dental health enhancers, or any combination thereof.

The breath freshening content may include eucalyptus, spearmint, or peppermint additives, or any combination thereof.

The gel may be configured to keep a bacterial count of the device below a predetermined threshold.

The gel may be configured to cooperate with the dispensing member to keep a bacterial count of the dispensing member below a predetermined threshold.

The predetermined threshold may be about 1500 times less than a conventional animal water dispenser.

The hand-held device may further include indicia provided to the housing to correspond with a position of the pushing member to indicate that a predetermined amount of the edible substance has been dispensed from the dispensing member, wherein at least a portion of the housing is translucent such that the position of the pushing member may be viewed through the housing.

The hand-held device may further include first indicia provided to the housing, and second indicia provided to the control interface, wherein the first and second indicia are positioned to correspond when a predetermined amount of the edible substance has been dispensed from the dispensing member.

The hand-held device may further include a screw member provided in the housing and coupled to the control interface, wherein the control interface is rotatable, and rotation of the control interface and coupled screw member causes the pushing member to push the edible substance in a direction of the dispensing member.

The hand-held device may further include a removable cap member to fit over the dispensing member and substantially seal the hand-held device from external elements.

The hand-held device may further include a removable aperture clearing and closing member that is coupleable to the dispensing member, and may have projections that correspond to the at least one aperture of the dispensing member, to prevent the edible substance from spillage and/or exposure.

At least one aperture of the dispensing member may curve in one or more directions.

Example embodiments of the present general inventive concept can also be achieved by providing a method of training an animal, the method including providing an edible substance in a hand-held device, the hand-held device having a housing provided with an edible substance therein, a dispensing member provided at one end of the housing, the dispensing member having at least one aperture through which the edible substance is dispensed, a pushing member provided inside the housing to push the edible substance in a direction of the dispensing member, and a control interface to control the movement of the pushing member such that a user can control an amount of the edible substance that is provided to the animal through the dispensing member, manipulating the control interface to dispense a desired amount of the edible substance, and presenting the end of the housing having the dispensing member to the animal to consume the dispensed amount of the edible substance.

At least a portion of the housing may be translucent such that the position of the pushing member may be viewed through the housing, indicia may be provided to the housing to correspond with a position of the pushing member to indicate that a predetermined amount of the edible substance has been dispensed from the dispensing member, and the manipulating of the control interface may include causing the pushing member to move to a desired one of the indicia before presenting the hand-held device to the animal.

First indicia may be provided to the housing, and second indicia may be provided to the control interface, the first and second indicia may be positioned to correspond when a predetermined amount of the edible substance has been dispensed from the dispensing member, and the manipulating of the control interface may include moving a desired one of the second indicia on the control interface to correspond with a desired one of the first indicia on the housing before presenting the hand-held device to the animal.

Example embodiments of the present general inventive concept can also be achieved by providing a method of supplying an edible substance to an animal, including providing a housing with an edible substance therein, providing a dispensing member at one end of the housing, the dispensing member having at least one aperture through which the edible substance is dispensed, the dispensing member having a first surface in communication with the housing and a second surface opposing the first surface, providing a pushing member inside the housing to push the edible substance in a direction of the first surface of the dispensing member and through the at least one aperture, providing a control interface to control movement of the pushing member such that a user can selectively control an amount of edible substance that is pushed through the at least one aperture, wherein a viscosity of the edible substance and a configuration of the at least one aperture cooperate to facilitate adherence of a selected amount of edible treat on the dispensing member adjacent to the second surface of the dispensing member, and supplying the selected amount of edible substance to the animal by presenting the second surface of the dispensing member to the animal's mouth.

### BRIEF DESCRIPTION OF THE SEVERAL VIEWS OF THE DRAWINGS

The example features of the present general inventive concept will become more clearly understood from the following detailed description in conjunction with the drawings, in which:

FIG. 1 illustrates an application of a liquid treat dispenser according to an example embodiment of the present general inventive concept;

FIG. 2 is a perspective view of an exemplary liquid treat dispenser according to an example embodiment of the present general inventive concept;

FIG. 3 is a detail view of the exemplary liquid treat dispenser according to an example embodiment of the present general inventive concept;

FIG. 4 is a detail view of the exemplary liquid treat dispenser with the cap installed according to an example embodiment of the present general inventive concept;

FIG. 5 illustrates an application of a dispensing unit according to an example embodiment of the present general inventive concept;

FIG. 6 illustrates a partially exploded perspective view of a dispensing unit according to an example embodiment of the present general inventive concept;

FIG. 7 illustrates a cut-away view of the dispensing unit according to an example embodiment of the present general inventive concept;

FIG. 8 illustrates a perspective view of the dispensing unit with a covering cap installed according to an example embodiment of the present general inventive concept;

FIG. 9 illustrates a partially exploded view of an embodiment of a dispensing unit with a combination of tamping cap matched to the dispensing grate and a covering cap according to an example embodiment of the present general inventive concept;

FIG. 10 illustrates a perspective view of a dispensing unit according to another example embodiment of the present general inventive concept; and

FIG. 11 is a graph illustrating bacterial presence in a conventional water dispenser as compared to a dispensing unit according to an example embodiment of the present general inventive concept.

### DETAILED DESCRIPTION OF THE INVENTION

Reference will now be made to various embodiments of the present general inventive concept, examples of which are illustrated in the accompanying drawings, wherein like reference numerals refer to like elements throughout. The following description of the various example embodiments is merely exemplary in nature and is in no way intended to limit the present general inventive concept, its application, or uses. The example embodiments are merely described below in order to explain the general inventive concept by referring to the figures.

It is noted that the term ‘consumable’ or ‘substance’ may be interchangeably referred to herein as a ‘treat,’ ‘gel,’ or ‘edible substance’ for convenience of description, but the present general inventive concept is not limited to any particular type of edible animal consumable, treat, or substance.

The following detailed description and claims may recite various descriptive terms such as horizontal, vertical, top, bottom, upward, downward, left, right, etc., when referring to the exemplary figures, but the present general inventive concept is not limited to any such terms or physical orientations. Such terms are used for convenience of description only, and could be reversed, modified, or interchanged without departing from the broader scope and spirit of the present general inventive concept. Embodiments of the present general inventive concept provide systems and methods of dispensing consumables, often called “treats,” to animals using a handheld dispenser that can deliver either a predetermined or a user-determined amount of a liquid or gel treat to supply the treat to the animal when the animal licks the dispensing portion of the apparatus.

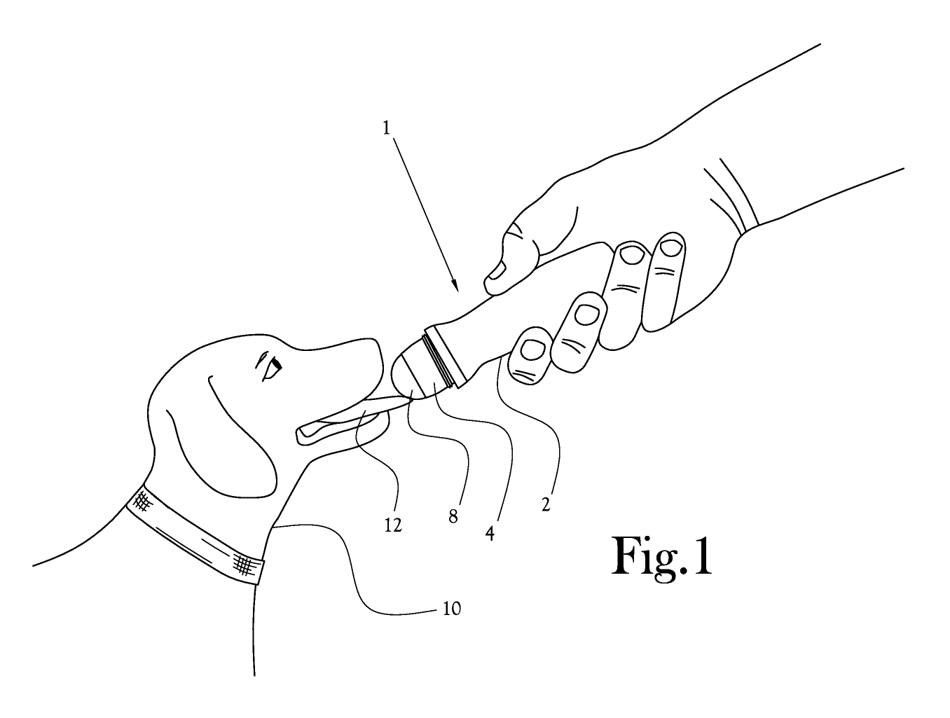

FIG. 1 illustrates an application of a liquid treat dispenser 1 according to an example embodiment of the present general inventive concept. The exemplary liquid treat dispenser 1 is configured in a relatively small, handheld size to be handled by a person's hand, and can be easily carried by the pet owner, for example in a pocket or purse, when not in use, giving the pet owner ready access to the treat. The convenient structure of the liquid treat dispenser 1 will enable the owner to quickly and easily provide many more treat instances to the animal throughout the time the pet and owner are together, improving consistency and training of the animal. The exemplary liquid treat dispenser of the present general inventive concept can be fabricated from conventional materials of construction, such as plastic(s), rubber(s), synthetic(s), and the like, but the present general inventive concept is not limited to any particular material(s) of construction.

As illustrated in FIG. 1, the liquid treat dispenser 1 includes a handle portion 2, an annular flanged opening 4, and a roller ball 8. The annular flanged opening 4 is disposed at one end of the handle portion 2 to receive the roller ball 8 therein, and includes an inwardly curved surface configured in shape and size to rotatably capture, circumferentially, the roller ball 8 within the opening 4. The roller ball 8 and flanged opening 4 are dimensioned such that the roller ball 8 can freely rotate within the flanged opening 4, while remaining captured within the opening 4 to minimize axial movement of the roller ball 8. Accordingly, based on the manner in which the roller ball 8 is captured within the flanged opening 4, the roller ball 8 is capable of rotatable movement with respect to the flanged opening 4, and limited axial movement relative to the handle portion 2. The outside surface of the handle portion 2 can be contoured for gripping by the hand of the pet owner.

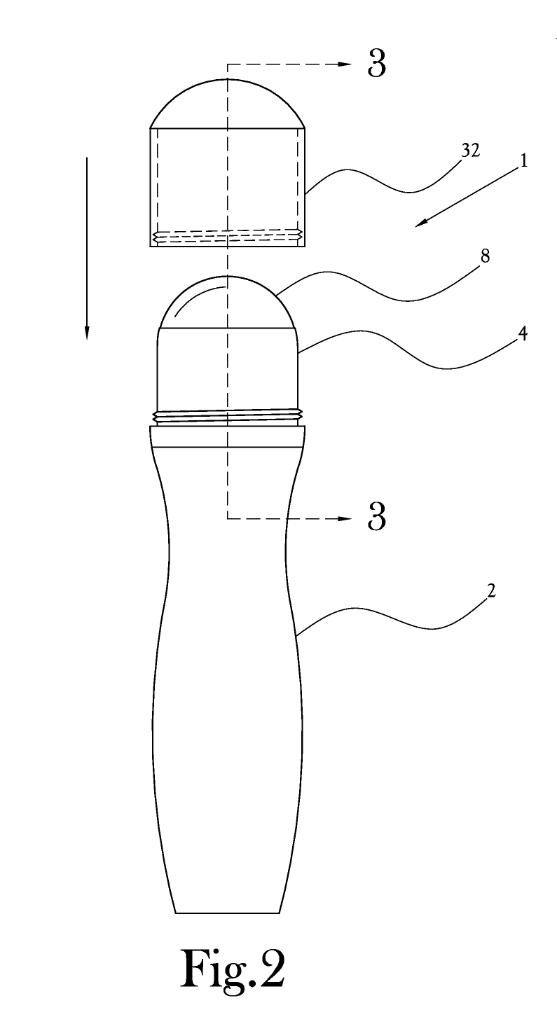

FIG. 2 illustrates an example configuration of a roller ball 8 rotatably installed in the flanged opening 4 of the handle portion 2. Referring to FIG. 2, an exposed surface (i.e., upper surface in FIG. 2) of the roller ball 8 is configured to protrude beyond the end of the flanged opening 4, i.e., beyond the centerline of the roller ball 8 to facilitate capture of the roller ball 8 in the flanged opening 4. For example, it is possible to capture the roller ball 8 in the flanged opening 4 by dimensioning the flanged opening to include an inwardly curved end extending slightly beyond the centerline of the roller ball 8 such that the roller ball 8 is rotatably captured within the flanged opening 4. The dispenser 1 can include a detachable cap 32 to cover the top end of the dispenser 1.

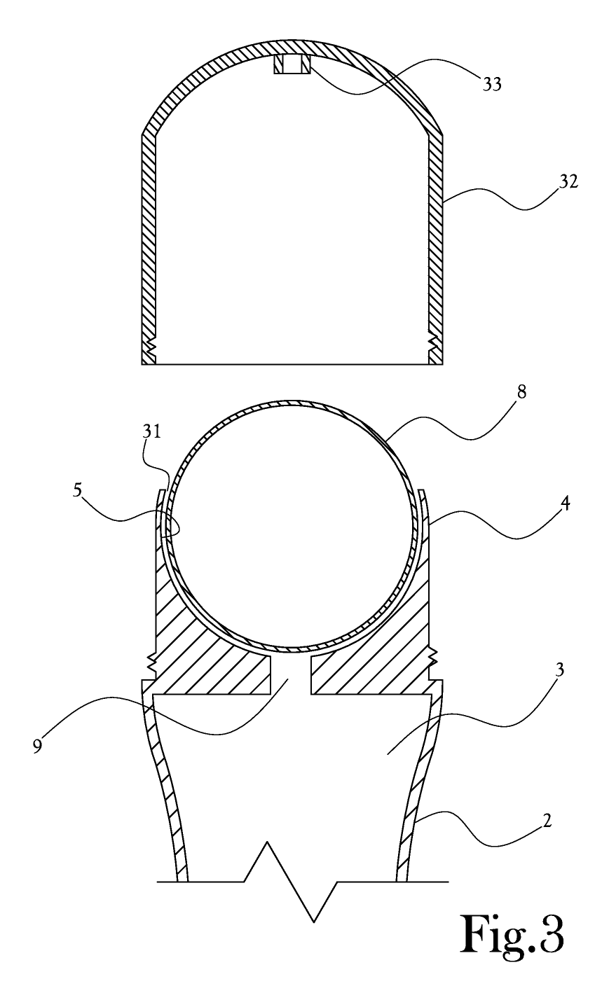

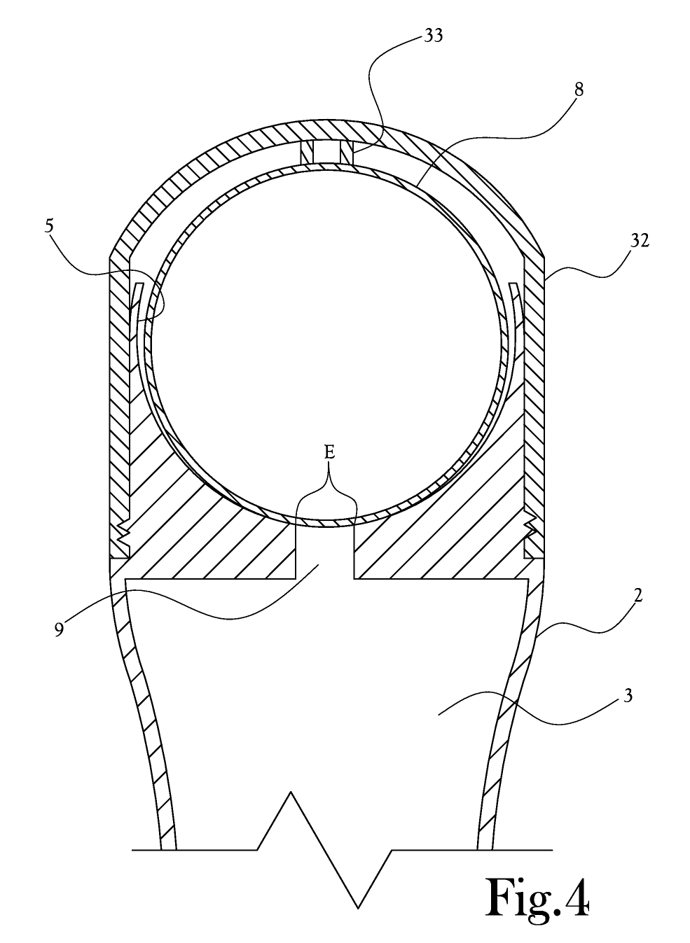

Referring to FIGS. 3 and 4, the liquid treat dispenser 1 can include a threaded cylindrical cap 32 to be detachably secured to the outside neck portion of the liquid treat dispenser 1 by threading the cap 32 onto the mating threads of the neck portion, as illustrated in FIG. 3. An example operation of the threaded cap 32 will be described in more detail below in connection with FIG. 4.

FIG. 3 is a detail view of the exemplary liquid treat dispenser according to an example embodiment of the present general inventive concept. As illustrated in FIG. 3, a relatively narrow gap 31 can be provided between an inside surface 5 of the flanged opening 4 and the outside diameter of the roller ball 8, with results being that the roller ball 8 is permitted to float slightly within the flanged opening 4 when the underside of the roller ball 8 is communicating with the liquid treat substance (not illustrated) stored inside the storage chamber 3, as exemplified by the substantially continuous gap 31 disposed around the underside of the roller ball 8.

Referring to FIG. 3, the handle portion 2 includes a hollow storage chamber 3 to store a quantity of liquid treat substance therein. The liquid treat substance can have a predetermined viscocity and/or can be a water-based substance having a flavor or scent that is appealing to the animal. For example, it is possible that the liquid substance could be water, grease, fats, or any other type of processed or naturally occurring fluid or gel to be consumed by the animal, and may include functional additives such as vitamins, herbs, electrolytes, and the like, to aid in the overall health of the pet, and may include multiple flavor offerings. The edible substance may be a gel having at least one additive to provide one or more health promoting qualities to the animal. For example, in various example embodiments in which a consumable gel is provided in the dispensing device, the gel may be a malleable consumable including formulated ingredients to freshen breath and prevent build-up of tartar and plaque leveraging ingredients and antimicrobial additives or other preservatives to enhance health benefits for the animal, and to reduce bacterial colonization and/or contamination of the consumable substance. However, the present general inventive concept is not limited to any particular type of fluid or liquid substance.

As illustrated in FIG. 3, an internal passageway 9 can be provided between the storage chamber and the flanged opening 4 to permit the flow of liquid treat from the storage chamber 3 to the underside of the roller ball 8. The storage chamber 3 stores a volume the liquid treat substance, from which a predetermined amount can be delivered to the animal via the roller ball 8. The diameter of the roller ball 8 and the size and shape of the flanged opening 4 can be configured to permit the roller ball 8 to rotate freely within the flanged opening 4. In this configuration, the flow of liquid substance through the passageway 9 enables the roller ball 8 to pick-up a quantity of the liquid treat as the pet is licking the ball 8 to facilitate a smooth and even dispensing of the liquid to the animal with each lick.

As illustrated in FIG. 3, passageway 9 can facilitate fluidic communication between the storage chamber 3 and the underside of the roller ball 8 when the handle portion 2 is inverted due to gravitational forces, and the roller ball 8 can buoyantly float within the gap 31 as the liquid treat substance is communicating with the underside of the roller ball 8. For example, when the liquid treat dispenser 1 is shaken or when the open end of the handle portion 2 is pointing in a downward direction (i.e. toward the ground), it is possible for the liquid treat substance stored in the storage chamber to flow through the passageway 9 such that the liquid treat can contact at least a portion of an underside of the roller ball 8 causing a gap 31 to form between the outer surface of the roller ball 8 and the inner surface of the opening 4. Due to the physical and/or chemical characteristics of the liquid substance and roller ball 8, such as viscosity, texture, and the like, a portion of the liquid treat can be coated or adhered to the underside of the roller ball 8 as the liquid treat contacts the underside of the roller ball 8. The roller ball 2 may include a textured surface configured to facilitate adherence of the liquid treat substance to the surface of the roller ball 8 when the liquid substance contacts the roller ball 8. In other example embodiments, it is possible that the handle portion 2 could be designed as a squeeze bottle, enabling a user to squeeze the handle portion 2 to create an internal pressure within the storage chamber 3 to force the liquid treat against the roller ball 8 to facilitate delivery of the liquid treat to the animal as the animal licks and rotates the roller ball 8.

When the roller ball 8 of the liquid treat dispenser 1 is presented to the animal 10 as illustrated in FIG. 1, the open end of the hand held dispenser and the exposed surface of the ball 8 are oriented substantially downward such that the animal can lick the exposed surface of the roller ball 8 with its tongue 12. When the animal licks the exposed surface of the roller ball 8, the animal's licking action can cause the roller ball 8 to rotate within the flanged opening 4, with results being that a portion of the liquid substance can be delivered from the underside of the roller ball 8 through the gap 31 to the tongue of the animal, allowing the animal to consume the liquid treat, as illustrated in FIG. 3. The size of the gap 31 can be dimensioned to permit a predetermined thickness of the adhered liquid treat to pass therethrough, facilitating smooth and even delivery of a predetermined quantify of liquid treat to the animal.

Referring to FIG. 3, the gap 31 between the circumferential surface 5 and the roller ball 8 can facilitate a smooth and even dispensing of the liquid when the roller ball 8 is licked by the pet. That is, the gap 31 can be dimensioned to enable passage of only a predetermined thickness of the liquid substance adhered to the ball, to control the amount of liquid being delivered to the animal with each lick. Moreover, when the pet's licking action ceases, the gap 31 between the circumferential surface 5 and the roller ball 8 can be small enough to prevent undesired passage of viscous liquid when the roller ball 8 is not being rotated, thus minimizing undesired liquid dispersal through the roller ball 8, even when the liquid treat dispenser 1 remains in an inverted orientation, as illustrated in FIG. 1.

FIG. 4 is a detail view of the exemplary liquid treat dispenser with the cap 32 installed to cover the exposed surface of the roller ball 8 to prevent undesired liquid dispersal when the liquid treat dispenser 1 is not in use according to an example embodiment of the present general inventive concept.

Referring to FIGS. 3 and 4, the liquid treat dispenser 1 can include a threaded cylindrical cap 32 to be detachably secured to the outside neck portion of the liquid treat dispenser 1 by threading the cap 32 onto mating threads of the neck portion. As illustrated in FIG. 3, a protrusion 33 can be provided under the top surface of the cap 32 to contact the exposed surface of the roller ball 8 when the cap 32 is installed on the dispenser 1.

For example, as illustrated in FIG. 4, the protrusion 33 can be dimensioned to press the roller ball 8 against a bottom surface of the flanged opening 4 when the cap 32 is installed over the roller ball 8, enabling the underside of the roller ball 8 to contact and seal against the edges E of the passageway 9, thereby creating a seal around the passageway 9 and preventing unwanted dispersal of liquid treat through the passageway 9 into the gap 31 when the cap 32 is installed on the dispenser 1. The contacting force of the protrusion 33 against the top surface of the roller ball 8 inhibits the roller ball 8 from rotating with respect to the flanged opening 4.

When the cap 32 is removed from the top of the dispenser, the roller ball 8 is free to rotate with respect to the flanged opening 4. The amount of the liquid substance being picked up and delivered to the pet can be metered and controlled by the characteristics and dimensions of the ball, liquid, and openings. For example, when the open end of the handle 2 is fully or partially inverted as illustrated in FIG. 1, the downward pressure of the liquid substance within the storage chamber 3 allows the liquid substance to continuously flow to the roller ball 8. Accordingly, as the pet licks the ball 8, a metered amount of the liquid substance can be consumed by the pet by licking and rotating the roller ball 8 based on the width of the gap 31. It is also possible to dimension the diameter and texture of the ball to pick-up, or adhere, a predetermined amount of the liquid, according to the physical properties of the ball and the viscosity of the liquid. In this way, it is possible that the pet can be satisfied by the palatable taste of the liquid substance, yet the pet need not consume a large quantity of the substance to feel that a reward was given, thus reducing the amount of calories and cost of treats being delivered to the animal and preventing the animal from being satiated from multiple treats during training exercises. For example, the apparatus and techniques of the present general inventive concept make it possible to provide frequent, smaller size rewards to a pet to improve training opportunities, without satiating the animal and without creating a sense of bloating and/or lethargy in the animal which can result from the frequent ingestion of larger quantity solid or fattening treats.

Moreover, referring to FIG. 3, considering the physical characteristics and quantity of liquid treat that can be delivered by exemplary treat dispensers configured in accordance with the present general inventive concept, it is possible to design the shape and size of the roller ball 8, gap 31, and flanged opening 4 to establish a predetermined amount, or calorie per lick (calorie/lick), provided to the animal, based on the physical characteristics of the ball and liquid. For example, by adjusting the tolerances of the gap 31 between the roller ball 8 and the inner surface of the flanged opening 4, it is possible to control the amount of liquid being delivered to the animal with each lick, as the size of the gap 31 can facilitate the smooth and consistent dispensing of a predetermined amount of liquid treat to the animal with each lick. The apparatus and techniques of the present general inventive concept also make it possible to provide various additives such as glucosamine, herbs, vitamins, electrolytes, and the like, and combinations thereof, to supplement the base liquid treat formula to aid in the overall health and frequent refreshment of the pet. It is also possible to provide an adjustment mechanism, such as a dial or switch mechanism, or other suitable adjustment mechanism chosen with sound engineering judgment, to facilitate adjustment of the amount of liquid treat being delivered to the animal with each lick, based on the size, breed, or other characteristic elements of a particular animal, to improve training capabilities.

The present general inventive concept is not limited to any particular type of cap, and many other types of caps may be used to provide a protective cover for the roller ball 8 when the liquid treat dispenser 1 is not in use. For example, the cap 32 may be configured with a snap or other mechanical mechanism or attachment device to enable easy, one hand removal and replacement from the ball 8 and dispenser 1. It is also possible to configure the cap 32 to include a cleaning apparatus to contact the working surface of the roller ball and to keep the flange area of the dispenser clean.

As illustrated and described herein, example embodiments of the present general inventive concept can provide a liquid treat delivery system which utilizes a captured ball, or roller ball dispensing head using a roller ball, which seals against undesired spilling when the roller is withdrawn from the tongue of the pet. It is possible to configure the dimensions of the ball, the size of the gap between the ball and the flanged shoulder, and the viscosity of the liquid treat to assure a smooth and even dispensing of a predetermined amount of the liquid treat when the ball is licked by the pet. Accordingly, the size and shape of the delivery system can be configured to accommodate various sizes and types of animals, while maintaining a clean, convenient, consistent, healthy, and accessible system to store and deliver liquid food supplements to animals wherever and whenever the pet and pet owner spend time together without satiating the appetite of the animal, thus increasing the number of treats, refreshments, or rewards that can be provided to the animal over a given timeframe and/or to increase the number of training opportunities available for the animal and pet owner over the course of given activities.

The consumable substance provided to the animal may also have a high viscosity, for example a gel consumable, which may be provided to the animal by example devices constructed in accordance with additional example embodiments of the present general inventive concept.

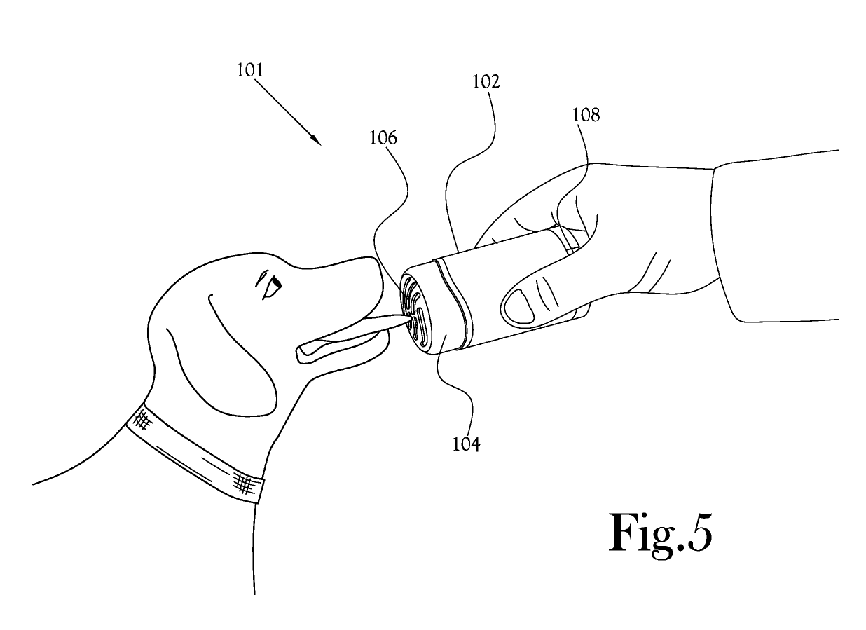

FIG. 5 illustrates an application of a dispensing unit 101, for example a gel-based treat dispensing unit, according to an example embodiment of the present general inventive concept. As illustrated in FIG. 5, the example dispensing unit 101 is configured in a relatively small, handheld size to be handled by a person's hand, and can be easily carried by the pet owner, for example in a pocket or purse, when not in use, giving the pet owner ready access to the animal consumable. The convenient structure of the dispensing unit 101 includes a housing where an edible consumable can be stored to enable the owner to quickly and easily provide many more feeding instances, via one or more apertures 106 in a dispensing member 104, to the animal throughout the time the pet and owner are together, improving consistency, nourishment, training, and enjoyment of the animal. Various example embodiments of the dispensing unit 101 of the present general inventive concept can be fabricated from conventional materials of construction, such as plastic(s), rubber(s), synthetic(s), and the like, but the present general inventive concept is not limited to any particular material(s) of construction. Also, various example embodiments of the dispensing unit are provided with a housing that is configured to preserve the edible gel provided inside against spoilage, contamination, etc.

The housing 102 and/or dispensing unit 104 can be configured to include a preservative coating or seal to improve the shelf-life and/or efficacy of the edible consumable stored therein. For example, the housing can be treated and/or configured in shape(s), material(s), and size(s) to preserve the edible gel, and can cooperate with the gel to provide health promoting qualities to the animal.

As illustrated in FIG. 5, the dispensing unit 101 includes a housing 102, a dispensing member 104, such as a grate, and a control interface 108. The dispensing member 104 is disposed at one end of the housing 102 and includes one or more apertures 106 through which the gel treat 107 may be dispensed. The control interface 108 may be positioned so that a pet owner may manipulate the control interface 108 while providing a gel treat 107 to the animal. The outside surface of the housing 102 may be contoured for gripping by the hand of the pet owner.

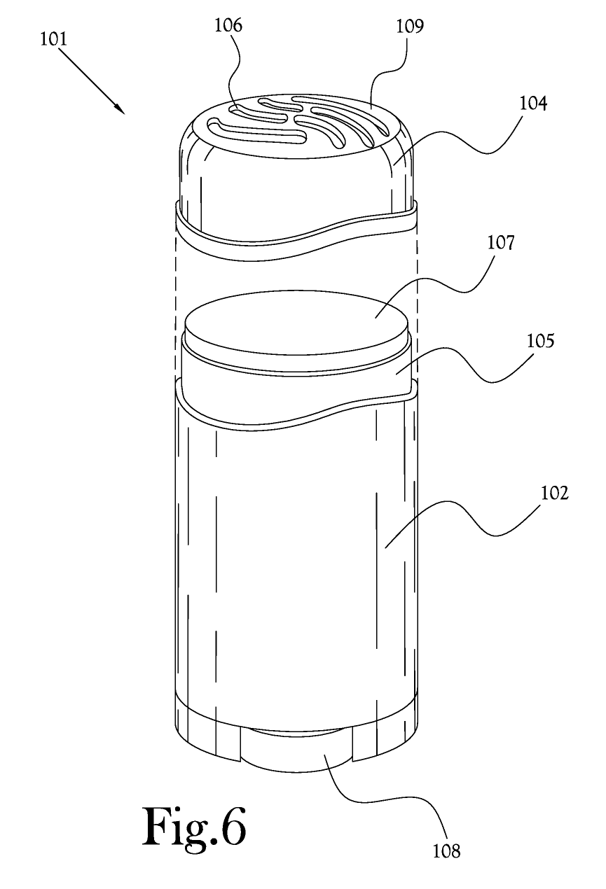

FIG. 6 illustrates an example configuration of the dispensing member 104 disconnected from the housing 102. In the illustrated embodiment, the housing 102 has a mating surface 105 that the dispensing member 104 connects to when the dispensing unit 101 is assembled. The dispensing member 104 may be attached through various means to the housing 102, such as, for example, but not limited to, surface friction, connectors, latches, pins, glues, or material bonding. In various examples of the present general inventive concept, the dispensing member 104 may be configured such that an end cap is attached to the housing 105 without any overlapping area. The dispensing member 104 defines at least one aperture 106 through which a gel treat 107 may be pushed, or dispensed, and a dispensing surface 109 that a pet may lick to consume the edible substance 107. The at least one aperture 106, which in this example embodiment includes a plurality of curved apertures 106, allows for a desired extruded portion of the edible substance 107 to be presented to the pet as determined by the owner, while the dispensing surface 109 serves to provide the pet with a platform to lick and/or retrieve the dispensed consumable 107 from and to limit access to the portion of the consumable 107 that has not been extruded. In various example embodiments, the provided gel is a malleable consumable configured be extruded through the at least one aperture 106. The gel consumable may have a viscosity sufficient to inhibit the gel from flowing through the apertures 106 due to gravitational forces when the dispenser is inverted. The at least one aperture 106 and dispensing surface 109 can be realized in several sizes, shapes, orientations, patterns, and textures to provide pets with different feeding patterns and/or tongue sizes better access to the edible substance 107 or a more stimulating reward from the owner. For example, the apertures 106 may be curved in one or more directions, which may allow the higher viscosity gel to take and maintain a shape of the apertures as the gel is pushed through the apertures, and to remain extended from and adjacent to the dispensing surface 109 in a more upright, solidified, fashion, rather than collapsing onto the dispensing surface 109 and possibly sliding off of the dispensing surface 109 before being supplied to the animal. The dispensing surface 109 may be configured opposite to an under surface of the dispensing member 104, the under surface being in communication with the inside of the housing where the gel is stored, and facing the pushing member 110.

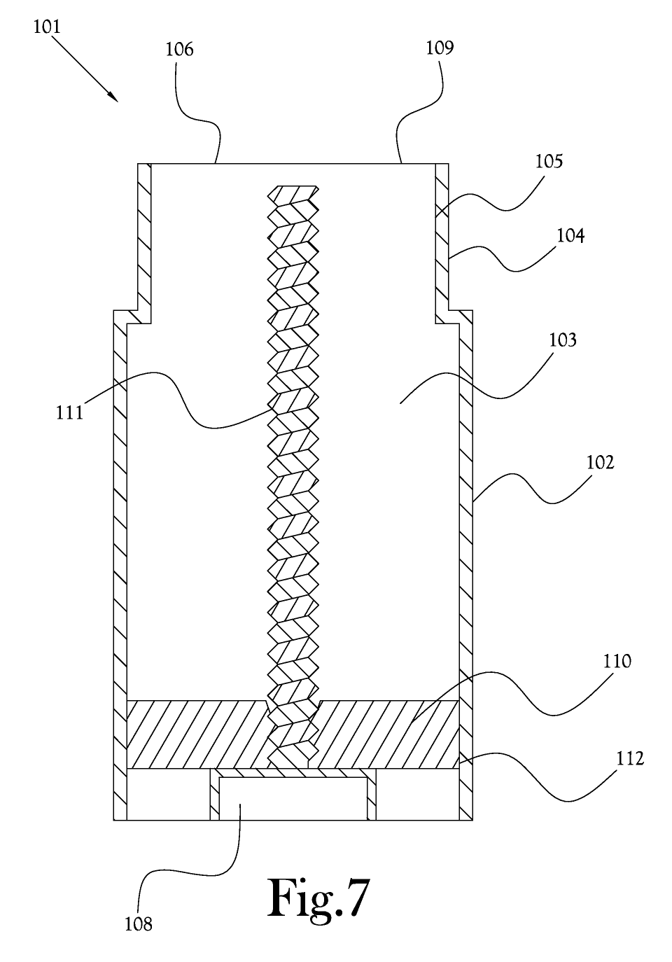

FIG. 7 illustrates a cut-away view that details an example configuration of the delivery mechanisms for an embodiment of the dispensing unit 101. The housing 102 defines a storage chamber 103 in which an edible substance 107 is held for extrusion. Extrusion occurs when a pushing member 110 pushes the edible substance 107 toward the dispensing member 104 and forces it out of the apertures 106. The pushing member 110 in the illustrated embodiment is provided in the storage chamber 103 with a substantially equal cross section to the storage chamber 103 to form a seal 112 against the storage chamber 103 so that as the pushing member 110 advances to the dispensing member 104, the edible substance 107 is also advanced.

The user can control advancement of the pushing member 110, and thereby selectively control the amount of edible substance 107 pushed through the aperture(s) and made available to the pet, through a control interface 108, which is illustrated in FIG. 7 as a rotatable knob that is coupled to a screw member 111. In this embodiment, as the control interface 108 knob is rotated, the screw member 111 is also rotated, which causes the pushing member 110 through which the screw member is threaded to advance or retract, depending on the direction of rotation. One skilled in the art will recognize that the control interface 108 is not limited to the illustrated embodiment and may include, for example, push-pull diaphragms, pumps, or ratcheting screw members. In other various example embodiments, the housing 102 may be designed to act as a control interface 108, such as, for example, a squeeze bottle, enabling a user to squeeze the housing 102 to create an internal pressure within the storage chamber 103 to force the edible substance 107 through the dispensing member 104 to facilitate delivery of the edible substance 107 to the animal as the animal licks the dispensing surface 109.

Referring to FIG. 7, the example housing 102 includes a hollow storage chamber 103 to store a quantity of the edible substance 107 substance therein. The edible substance 107 may have a predetermined viscosity and/or may be a paste-like substance having a flavor or scent that is appealing to the animal. For example, in various example embodiments the edible substance 107 may include water, grease, fats, or any other type of processed or naturally occurring fluid or gel to be consumed by the animal, and may include functional additives such as vitamins, herbs, electrolytes, and the like, to aid in the overall health and/or well-being of the pet, and may include multiple flavor offerings. For example, the edible substance 107 may include nutritional content such as antioxidants, anti-stress additives, antimicrobials, preservatives, skin and coat additives, immunity additives, digestive additives, bone and joint additives, or any combination thereof. The edible substance may also include additives to aid in stress and weight management, as well as enhancing energy, cognitive development and/or abilities of the animal, and the like, and can be formulated according to a specific life stage of the animal. As another example, the edible substance 107 may include breath freshening content including eucalyptus, spearmint, or peppermint additives, or any combination thereof. However, the present general inventive concept is not limited to any particular type of fluid or gel substance.

Moreover, referring to FIG. 7, considering the physical characteristics and quantity of edible substance 107 that can be delivered by example dispensers configured in accordance with example embodiments of the present general inventive concept, it is possible to design the shape and size of the dispenser member 104 and control interface 108 to establish a predetermined amount, or calorie per lick (calorie/lick), provided to the animal, based on the physical characteristics of the dispenser 101 and edible substance 107. For example, by adjusting the tolerances and pitch of the threads of the screw member 111, it is possible to control the amount of gel being delivered to the animal with each lick, as the pitch of the screw member 111 can facilitate the smooth and consistent dispensing of a predetermined amount of edible substance by the pushing member 110 out of the apertures 106 for a given rotation of the control interface 108 knob.

This can be an effective training aid for animals, as it enables an animal trainer to present the animal with a selected amount of edible substance, based on a particular training regimen. For example, a trainer may provide an animal with relatively small amounts of a treat at various stages of a given training routine, and then present the animal with a ‘jackpot’ (i.e., relatively large amount), at the conclusion of a successful activity or routine, enhancing the timing and value of given training opportunities.

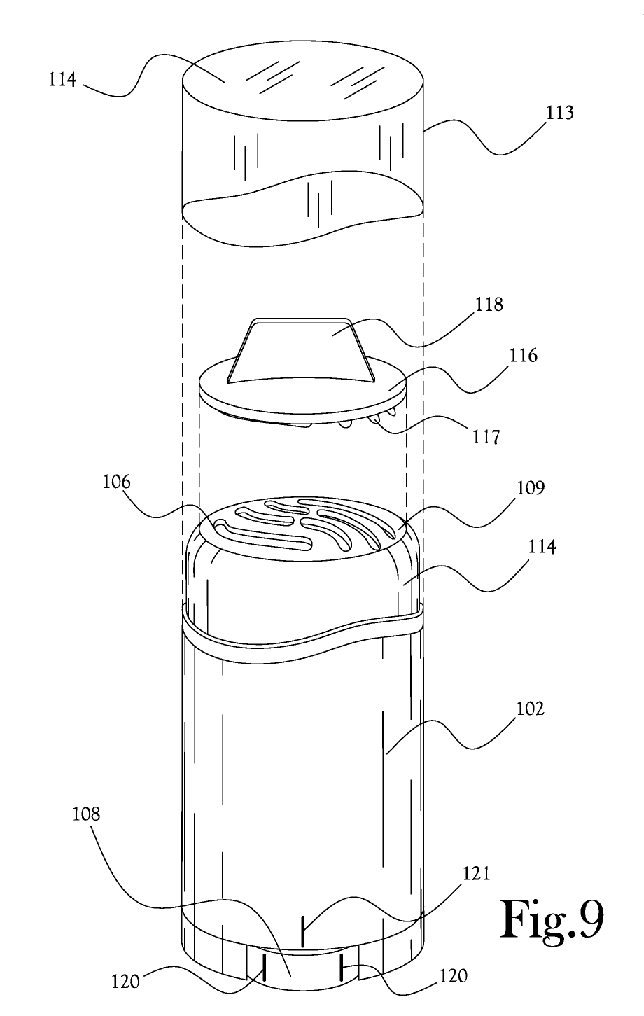

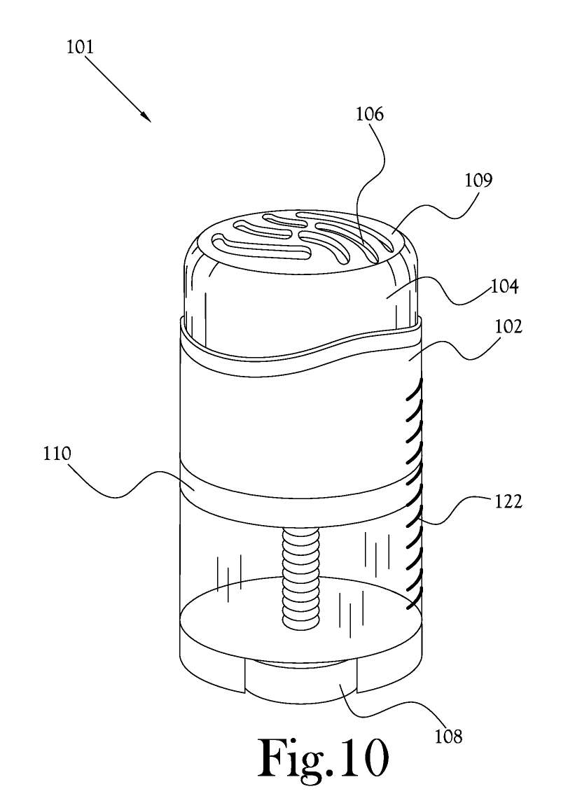

Examples of the dispensing of predetermined quantities of the edible substance 107 will be described in more detail with regard to FIGS. 9 and 10. The systems and techniques of the present general inventive concept also make it possible to provide various additives such as glucosamine, herbs, vitamins, electrolytes, and the like, and combinations thereof, to supplement the base edible substance formula to aid in the overall health, well-being, enjoyment, and frequent refreshment of the pet. It is also possible to provide an adjustment mechanism, such as a dial or switch mechanism, or other suitable adjustment mechanism chosen with sound engineering judgment, to facilitate adjustment of the amount of edible substance being delivered to the animal with each lick, based on the size, breed, or other characteristic elements of a particular animal, to improve training capabilities.

In this way, it is possible that the pet can be satisfied by the palatable taste of the edible substance, yet the pet need not consume a large quantity of the substance to feel that a reward was given, thus reducing the amount of calories and cost of treats being delivered to the animal and preventing the animal from being satiated from multiple treats during training exercises. For example, the apparatus and techniques of the present general inventive concept make it possible to provide frequent, smaller size rewards to a pet to improve training opportunities, without satiating the animal and without creating a sense of bloating and/or lethargy in the animal, which can result from the frequent ingestion of larger quantity solid or fattening treats.

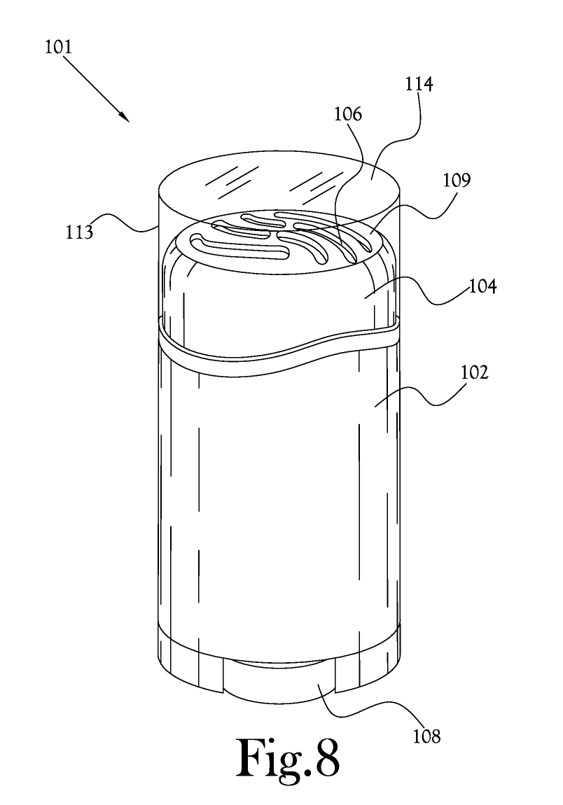

FIG. 8 illustrates one embodiment of a covering cap 113 for the dispensing unit 101 to be detachably secured to cover the apertures 106 in the dispensing member 104 to prevent undesired gel dispersal when the dispensing unit 101 is not in use according to an example embodiment of the present general inventive concept. By covering the apertures 106, the covering cap 113 can prevent the edible substance 107 from being exposed except during use of the dispensing unit 101. Preventing exposure of the edible substance 107 can help prolong the shelf-life and efficacy of the edible substance 107, limit the spread of odors associated with the edible substance 107, and aid in cleanliness by containing unconsumed edible substance 107 left on the dispensing surface 109 or edible substance 107 unintentionally extruded when the dispenser 101 is not in use. The covering cap 113 is illustrated as defining an overflow cavity 114, but may lie substantially flush against the dispensing surface 109 in various other example embodiments. The covering cap 113 is illustrated as being detachably secured to the outside neck portion of the dispensing unit 101, but may also be secured to the dispensing member 104. The covering cap 113 may be secured with surface friction to the dispensing unit 101 or dispensing member 104, or secured with pins, latches or with a screw-on connection if the covering cap 113 and dispensing unit 101 are shaped to allow for threaded connectors.

Although not illustrated in FIG. 8, one or more protrusions may be provided under the top surface of the covering cap 113 to contact the dispensing surface 109 of the dispensing member 104 when the covering cap 113 is installed on the dispenser 101. Such protrusions may correspond to the apertures 106 in a fashion similar to the cleaning apparatus described later in regard to FIG. 9.

The present general inventive concept is not limited to any particular type of cap, and many other types of caps may be used to provide a protective cover for the dispensing member 104 when the dispensing unit 101 is not in use. For example, the covering cap 113 may be configured with a snap or other mechanical mechanism or attachment device to enable easy, one hand removal and replacement from the dispensing member 104 and dispenser 101. It is also possible to configure the covering cap 113 to include a cleaning apparatus to contact the working surface of the dispensing member 104 and to keep the dispensing surface 109 of the dispenser 101 clean.

FIG. 9 illustrates an example of a cleaning apparatus for use with an embodiment of the current general inventive concept. The cleaning apparatus is a tamping cap 116, which includes a set of tamps 117 configured to correspond to the apertures 106 and move any remaining edible substance 107 back into the storage chamber 103. The tamping cap 116 may be a component used in conjunction with the covering cap 113 illustrated in FIG. 5, part of the covering cap 113, or used as an embodiment of the covering cap 113. When used in conjunction with a covering cap 113 illustrated in the embodiment of FIG. 5, the tamping cap 116 may have a handle 118 to allow easy replacement or removal of the tamping cap 116. In various example embodiments the tamping cap 116 may be stored within the overflow cavity 114 when the dispenser 101 is not in use.

As previously discussed, various components of the dispenser 101 may be configured such that a desired amount of the edible substance 107 may be dispensed by the user. Referring to the example embodiment illustrated in FIG. 9, for example, indicia 120 and 121, which are line markings in this example, have been provided to allow a user to dispense a predetermined amount of the edible substance 107 by twisting the control interface 108 until one of the markings 120 on the control interface is aligned with the marking 121 on the housing 102. Therefore, substantially the predetermined amount of edible substance 107 that corresponds with such configured indicia will be dispensed from the dispensing member 104 each time the control interface 108 is rotated from one position at which the indicia 120 and 121 align to the next position at which the indicia 120 and 121 align. Such indicia 120 and 121 may be provided in various different ways according to various example embodiments of the present general inventive concept. For example, the indicia 120 and 121 may be printed, notched, labeled, etc., on the control interface 108 and housing 102.

FIG. 10 illustrates a perspective view of the dispensing unit according to another example embodiment of the present general inventive concept. Similar to the example embodiment illustrated in FIG. 9, the example embodiment of FIG. 10 is provided with indicia to aid the user in determining when a desired amount of the edible substance 107 is dispensed through the dispensing member 104. However, in the example embodiment of FIG. 10, the housing 102 is configured to be translucent, and a single set of indicia 122 are provided on the housing 102 to correspond with a position of the pushing member 110. For example, if a dispensing action begins when the top surface of the pushing member 110 is aligned with one of the indicia 122 provided on the housing 102, the predetermined amount of edible substance 107 that corresponds to the provided indicia 122 is dispensed when the top surface of the pushing member 110 reaches the next adjacent one of the indicia 122. This allows a user to easily dispense the predetermined amount of the edible substance 107 to the animal. The provided indicia of various example embodiments of the present general inventive concept may correspond to predetermined amounts of calories or any other quantifiable aspect of the edible substance 107. As with the indicia 120 and 121 illustrated in FIG. 9, the indicia 122 provided in FIG. 10 may be printed, notched, labeled, etc., on the housing 102 of the dispensing unit 101. While it is possible for the entirety of the housing 102 to be translucent, the present general inventive concept is not limited to such a configuration. For example, in various other example embodiments only a portion of the housing 102 may be translucent, such as an area containing the indicia 122, or a visual window to view the contents within the housing 102 and/or observe the movement of the pushing member 110 and/or gel.

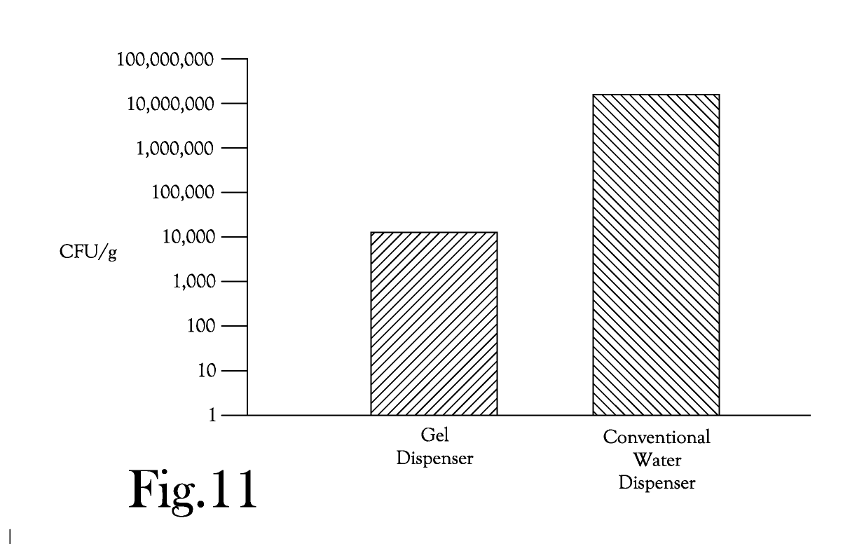

FIG. 11 is a graph illustrating bacterial presence in a conventional water dispenser as compared to a dispensing unit according to an example embodiment of the present general inventive concept. Due to one or more additives that may be included in the edible substance, such as a gel, according to various example embodiments of the present general inventive concept, the edible substance itself may be configured to have preservative qualities or other health promoting qualities. For example, as illustrated in FIG. 11, the gel can be configured to keep bacterial presence of the device below a desired threshold. This threshold may be significantly less than the bacteria present in a typical water dispenser, dog's chew toy, etc. Referring to FIG. 11, it has been shown by example research that gel's configured according to example embodiments of the present general inventive concept can reduce contamination by a significant percentage, even exponentially in some cases, when compared to conventional toys, treats, dispensers, etc. In some embodiments the gel and dispenser can be configured to cooperate with each other to enhance health promoting qualities and reduce a bacterial count of the device, for example a bacterial count proximate the dispensing member. As indicated in FIG. 11, which compares an example embodiment of a gel dispenser according to the present general inventive concept with a conventional water dispenser, the untreated water of the conventional water dispenser had 1,500 times more colony forming units (CFU's) than the gel dispenser. Research has provided similar results demonstrating improved antibacterial characteristics of the present device compared with other known handheld devices, toys, dispensers, etc.

As illustrated and described herein, various example embodiments of the present general inventive concept provide an edible substance delivery system, which utilizes a dispensing member, which controls the amount of treat available to the tongue of the pet. It is possible to configure the dimensions of the grate, the size of the apertures in the grate, and the viscosity of the edible substance to assure a smooth and even dispensing of a user-determined amount of the edible substance to provide to the pet. Accordingly, the size and shape of the delivery system can be configured to accommodate various sizes and types of animals, while maintaining a clean, convenient, consistent, healthy, and accessible system to store and deliver gel food supplements to animals wherever and whenever the pet and pet owner spend time together without satiating the appetite of the animal, thus increasing the number of treats, refreshments, or rewards that can be provided to the animal over a given timeframe and/or to increase the number of training opportunities available for the animal and pet owner over the course of given activities.

While the present general inventive concept has been illustrated by description of example embodiments and while the illustrative embodiments have been described by referring to the drawings, it is not the intention of the applicant to restrict or in any way limit the scope of the appended claims to the illustrative examples. It is noted that numerous variations, modifications, and additional embodiments are possible, and accordingly, all such variations, modifications, and embodiments are to be regarded as being within the spirit and scope of the present general inventive concept. The present general inventive concept in its broader aspects is therefore not limited to the specific details, representative apparatus and methods, and illustrative examples illustrated and described. Accordingly, departures may be made from such details without departing from the spirit or scope of applicant's general inventive concept.

1. A hand-held device to provide an edible substance to an animal, comprising:
a housing provided with an edible substance therein;
a dispensing member provided at one end of the housing, the dispensing member having at least one aperture through which the edible substance is dispensed, the dispensing member having a first surface in communication with the housing and a second surface opposing the first surface;
a pushing member provided inside the housing to push the edible substance in a direction of the first surface of the dispensing member and through the at least one aperture; and
a control interface to control the movement of the pushing member such that a user can selectively control an amount of the edible substance that is pushed through the at least one aperture, wherein a viscosity of the edible substance and a configuration of the at least one aperture cooperate to facilitate adherence of a selected amount of edible treat on the dispensing member adjacent to the second surface of the dispensing member.

2. The hand-held device of claim 1, wherein the edible substance is a gel having at least one additive to provide one or more health promoting qualities to the animal.

3. The hand-held device of claim 2, wherein the edible substance includes nutritional and/or breath freshening content.

4. The hand-held device of claim 3, wherein the nutritional content includes antioxidants, anti-stress additives, antimicrobials, preservatives, skin and coat additives, immunity additives, digestive additives, bone and joint additives, energy enhancers, weight management additives, cognitive enhancers, dental health enhancers, or any combination thereof.

5. The hand-held device of claim 3, wherein the breath freshening content includes eucalyptus, spearmint, or peppermint additives, or any combination thereof.

6. The hand-held device of claim 2, wherein the gel is configured to cooperate with the dispensing member to keep a bacterial count of the device below a predetermined threshold.

7. The hand-held device of claim 6, wherein the predetermined threshold is about 1500 times less than a conventional animal water dispenser.

8. The hand-held device of claim 1, further comprising:
indicia provided to the housing to correspond with a position of the pushing member to indicate that a predetermined amount of the edible substance has been dispensed from the dispensing member;
wherein at least a portion of the housing is translucent such that the position of the pushing member may be viewed through the housing.

9. The hand-held device of claim 1, further comprising:
first indicia provided to the housing; and
second indicia provided to the control interface;
wherein the first and second indicia are positioned to correspond when a predetermined amount of the edible substance has been dispensed from the dispensing member.

10. The hand-held device of claim 1, further comprising:
a screw member provided in the housing and coupled to the control interface;
wherein the control interface is rotatable, and rotation of the control interface and coupled screw member causes the pushing member to push the edible substance in a direction of the dispensing member.

11. The hand-held device of claim 1, further comprising a removable cap member to fit over the dispensing member and substantially seal the hand-held device from external elements.

12. The hand-held device of claim 1, further comprising a removable aperture clearing and closing member that is coupleable to the dispensing member, and having projections that correspond to the at least one aperture of the dispensing member, to prevent the edible substance from spillage and/or exposure.

13. The hand-held device of claim 1, wherein the at least one aperture of the dispensing member curves in one or more directions.

14. A method of training an animal, the method comprising:
providing an edible substance in a hand-held device, the hand-held device comprising:
a housing provided with an edible substance therein,
a dispensing member provided at one end of the housing, the dispensing member having at least one aperture through which the edible substance is dispensed,
a pushing member provided inside the housing to push the edible substance in a direction of the dispensing member, and
a control interface to control the movement of the pushing member such that a user can control an amount of the edible substance that is provided to the animal through the dispensing member;
manipulating the control interface to dispense a desired amount of the edible substance; and
presenting the end of the housing having the dispensing member to the animal to consume the dispensed amount of the edible substance.

15. The method of claim 14, wherein the edible substance is a gel having at least one additive to provide one or more health promoting qualities to the animal.

16. The method of claim 14, wherein at least a portion of the housing is translucent such that the position of the pushing member may be viewed through the housing;
indicia are provided to the housing to correspond with a position of the pushing member to indicate that a predetermined amount of the edible substance has been dispensed from the dispensing member; and
the manipulating of the control interface includes causing the pushing member to move to a desired one of the indicia before presenting the hand-held device to the animal.

17. The method of claim 14, wherein first indicia are provided to the housing, and second indicia are provided to the control interface;
the first and second indicia are positioned to correspond when a predetermined amount of the edible substance has been dispensed from the dispensing member; and
the manipulating of the control interface includes moving a desired one of the second indicia on the control interface to correspond with a desired one of the first indicia on the housing before presenting the hand-held device to the animal.

18. The method of claim 14, wherein the edible substance includes nutritional and/or breath freshening content.

19. The method of claim 18, wherein the nutritional content includes antioxidants, anti-stress additives, antimicrobials, preservatives, skin and coat additives, immunity additives, digestive additives, bone and joint additives, energy enhancers, weight management additives, cognitive enhancers, dental health enhancers, or any combination thereof.

20. The method of claim 15, wherein the gel is configured to keep a bacterial count of the dispensing member below a predetermined threshold.

21. The method of claim 20, wherein the predetermined threshold is about 1500 times less than a conventional animal water dispenser.

22. A method of supplying an edible substance to an animal, comprising:
providing a housing with an edible substance therein;
providing a dispensing member at one end of the housing, the dispensing member having at least one aperture through which the edible substance is dispensed, the dispensing member having a first surface in communication with the housing and a second surface opposing the first surface;
providing a pushing member inside the housing to push the edible substance in a direction of the first surface of the dispensing member and through the at least one aperture;
providing a control interface to control movement of the pushing member such that a user can selectively control an amount of edible substance that is pushed through the at least one aperture, wherein a viscosity of the edible substance and a configuration of the at least one aperture cooperate to facilitate adherence of a selected amount of edible treat on the dispensing member adjacent to the second surface of the dispensing member; and
supplying the selected amount of edible substance to the animal by presenting the second surface of the dispensing member to the animal's mouth.

23. The method of claim 22, wherein the edible substance is a gel having at least one additive to provide one or more health promoting qualities to the animal.

24. The method of claim 23, wherein the gel is configured to cooperate with the dispensing member to keep a bacterial count of the dispensing member below a predetermined threshold.
